(19) United States
(12) Patent Application Publication
(10) Pub. No.: US 2018/0336664 A1
(43) Pub. Date: Nov. 22, 2018

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Mitsuhiro Ono, Tokyo (JP)

(21) Appl. No.: 15/975,251

(22) Filed: May 9, 2018

(30) Foreign Application Priority Data
May 17, 2017 (JP) 2017-098410

(51) Int. Cl. G06T 5/00; H04N 5/232; G06T 7/11

(52) U.S. Cl. CPC G06T 5/002; G06T 2207/10048; G06T 7/11; H04N 5/23229

(57) ABSTRACT

There is provide an image processing apparatus comprising memory storing instructions. When executed by one or more processors, the instructions cause the image processing apparatus to perform operations comprising acquiring a visible light image generated by shooting a subject with visible light and an invisible light image generated by shooting the subject with invisible light, generating a difference image that represents a difference in luminance between the visible light image and the invisible light image, detecting, from the invisible light image, a first region in which variation of luminance is within a first range, and detecting, from the difference image, a second region in which variation of luminance is within a second range, and smoothing luminance in the visible light image regarding a region included in both the first region and the second region.

### BACKGROUND OF THE INVENTION

### Field of the Invention

The present invention relates to an image processing apparatus, an image processing method, and a storage medium.

### Description of the Related Art

Conventionally, noise suppression and object recognition have been performed by using an image shot with invisible light (for example, infrared light). For example, image capturing apparatuses configured to be able to create a composite image of an image acquired through visible light shooting and an image acquired through infrared light shooting in order to perform color image shooting in a low illuminance environment are known.

Japanese Patent Laid-Open No. 2006-180269 discloses an image processing apparatus for reducing noise in a visible light image. This image processing apparatus applies a low-pass filter to a visible light image so as to remove noise. Note that steep edge information is lost by applying the low-pass filter, and thus noise reduction and edge preservation are achieved by applying a high pass filter to an invisible light image (infrared light image) to extract edge information, and compositing the invisible light image with the visible light image from which noise has been removed.

In addition, Japanese Patent Laid-Open No. 2014-135627 discloses an image capturing apparatus for controlling the degree of amplification of color signals, color noise reduction, and a composition ratio of visible light luminance signals and invisible light luminance signals according to the values of the visible light luminance signals when compositing visible light signals and invisible light signals. According to Japanese Patent Laid-Open No. 2014-135627, when the visible light luminance is low, the composition ratio of invisible light signals is high.

There are cases where subject luminance differs between a visible light image and an infrared light image due to a difference in properties between infrared light and visible light. In this case, in composition processing of Japanese Patent Laid-Open No. 2006-180269 and Japanese Patent Laid-Open No. 2014-135627, there is a possibility that a desired composition result will not be acquired. A specific example will be described with reference to FIG. 1.

In FIG. 1, a visible light image 101 simulatively represents an image acquired by shooting, with visible light, a subject with a red letter “A” written on a white background, and an infrared light image 102 simulatively represents an image acquired by shooting the same subject with infrared light as invisible light. With visible light, the red letter portion is shot separately from the white background portion. On the other hand, in shooting using infrared light, there are cases where substantially no luminance difference occurs between the red letter portion and the white background portion, depending on the type of the ink of the letter and the wavelength properties of the image capturing device. In this case, in the infrared light image 102, there is substantially no boundary edge between the letter portion and the white background portion, and thus if a high pass filter is applied to the infrared light image 102, an edge enhancement effect is not achieved. Therefore, when composition processing of Japanese Patent Laid-Open No. 2006-180269 is performed, only an effect of a visible light low-pass filter is acquired, and thus, as shown in a composite image 103, a composition result is acquired in which the boundary between the letter portion and the white background portion is blurred. Also, when composition processing in Japanese Patent Laid-Open No. 2014-135627 is performed, in the letter portion of the visible light image 101 in which the luminance is low, a composition ratio of the infrared light image 102 in which the luminance is high is high. Therefore, as shown in the composite image 103, the luminance of the letter portion rises unnecessarily, and a composition result is acquired in which it is difficult to visually recognize the letter.

### SUMMARY OF THE INVENTION

The present invention has been made in view of such situations, and provides a technique for reducing noise components while suppressing deterioration of image quality.

According to a first aspect of the present invention, there is provided an image processing apparatus comprising: one or more processors; and memory storing instructions that, when executed by the one or more processors, cause the image processing apparatus to perform operations comprising: acquiring a visible light image generated by shooting a subject with visible light and an invisible light image generated by shooting the subject with invisible light; generating a difference image that represents a difference in luminance between the visible light image and the invisible light image; detecting, from the invisible light image, a first region in which variation of luminance is within a first range, and detecting, from the difference image, a second region in which variation of luminance is within a second range; and smoothing luminance in the visible light image regarding a region included in both the first region and the second region.

According to a second aspect of the present invention, there is provided an image processing apparatus comprising: one or more processors; and memory storing instructions that, when executed by the one or more processors, cause the image processing apparatus to perform operations comprising: acquiring a visible light image generated by shooting a subject with visible light and an invisible light image generated by shooting the subject with invisible light; generating a difference image that represents a difference in luminance between the visible light image and the invisible light image; and compositing luminance of the visible light image and luminance of the invisible light image in units of pixels, at a composition ratio determined in units of pixels based on an absolute value of a pixel of the difference image, wherein the compositing is, in a case where the absolute value is a first value, compositing corresponding pixels of the visible light image and the invisible light image at a first composition ratio, and in a case where the absolute value is a second value that is larger than the first value, compositing corresponding pixels of the visible light image and the invisible light image at a second composition ratio in which a ratio of the visible light image is larger than in a case of the first composition ratio.

According to a third aspect of the present invention, there is provided an image processing method executed by an image processing apparatus, comprising: acquiring a visible light image generated by shooting a subject with visible light and an invisible light image generated by shooting the subject with invisible light; generating a difference image that represents a difference in luminance between the visible light image and the invisible light image; detecting, from the invisible light image, a first region in which variation of luminance is within a first range, and detecting, from the difference image, a second region in which variation of luminance is within a second range; and smoothing luminance in the visible light image regarding a region included in both the first region and the second region.

According to a fourth aspect of the present invention, there is provided an image processing method executed by an image processing apparatus, comprising: acquiring a visible light image generated by shooting a subject with visible light and an invisible light image generated by shooting the subject with invisible light; generating a difference image that represents a difference in luminance between the visible light image and the invisible light image; and compositing luminance of the visible light image and luminance of the invisible light image in units of pixels, at a composition ratio determined in units of pixels based on an absolute value of a pixel of the difference image, wherein the compositing is, in a case where the absolute value is a first value, compositing corresponding pixels of the visible light image and the invisible light image at a first composition ratio, and in a case where the absolute value is a second value that is larger than the first value, compositing corresponding pixels of the visible light image and the invisible light image at a second composition ratio in which a ratio of the visible light image is larger than in a case of the first composition ratio.

According to a fifth aspect of the present invention, there is provided a non-transitory computer-readable storage medium which stores a program for causing a computer to execute an image processing method comprising: acquiring a visible light image generated by shooting a subject with visible light and an invisible light image generated by shooting the subject with invisible light; generating a difference image that represents a difference in luminance between the visible light image and the invisible light image; detecting, from the invisible light image, a first region in which variation of luminance is within a first range, and detecting, from the difference image, a second region in which variation of luminance is within a second range; and smoothing luminance in the visible light image regarding a region included in both the first region and the second region.

According to a sixth aspect of the present invention, there is provided a non-transitory computer-readable storage medium which stores a program for causing a computer to execute an image processing method comprising: acquiring a visible light image generated by shooting a subject with visible light and an invisible light image generated by shooting the subject with invisible light; generating a difference image that represents a difference in luminance between the visible light image and the invisible light image; and compositing luminance of the visible light image and luminance of the invisible light image in units of pixels, at a composition ratio determined in units of pixels based on an absolute value of a pixel of the difference image, wherein the compositing is, in a case where the absolute value is a first value, compositing corresponding pixels of the visible light image and the invisible light image at a first composition ratio, and in a case where the absolute value is a second value that is larger than the first value, compositing corresponding pixels of the visible light image and the invisible light image at a second composition ratio in which a ratio of the visible light image is larger than in a case of the first composition ratio.

Further features of the present invention will become apparent from the following description of exemplary embodiments with reference to the attached drawings.

### BRIEF DESCRIPTION OF THE DRAWINGS

FIG. 1 is a diagram showing examples of a visible light image, an infrared light image, and a composite image.

FIG. 2 is a block diagram showing a schematic configuration of an image capturing apparatus 200 that is an example of an image processing apparatus.

FIG. 3 is a functional block diagram related to processing for creating a difference image.

FIG. 4 is a flowchart of processing for creating a difference image.

FIG. 5 is a flowchart of noise reduction processing according to a first embodiment.

FIG. 6 is a diagram schematically showing a luminance profile corresponding to a position 111 of a subject shown in FIG. 1.

FIG. 7 is a flowchart of noise reduction processing according to a second embodiment.

FIG. 8 is a diagram showing the relationship between a pixel value of a difference image and a composition ratio.

FIG. 9 is a diagram showing a graph for determining a saturation correction amount.

FIG. 10 is a diagram showing a configuration example of a filter for generating a visible light image and an infrared light image.

FIGS. 11A to 11C are diagrams showing examples of histograms of a visible light image, an infrared light image, and a corrected visible light image.

### DESCRIPTION OF THE EMBODIMENTS

Hereinafter, embodiments of the present invention will be described with reference to the attached drawings. It should be noted that the technical scope of the present invention is defined by the claims, and is not limited by the following respective embodiments. Also, not all of the combinations of the aspects that are described in the embodiments are necessarily essential to the present invention. Also, the aspects that are described in the respective embodiments can be combined as appropriate.

### First Embodiment

Recent years has seen a trend of dark current noise and random component noise increasing as a result of image sensors such as CCD and CMOS that are used in digital cameras, mobile phones and the like having smaller sizes and an increasing number of pixels, and the size of individual pixels decreasing. In addition, accompanied by a decrease in sensitivity due to a decrease in the size of individual pixels, there is a trend of the degree of amplification in signal processing being increased to achieve a desired signal level, and noise in a shot image is likely to be conspicuous. In a first embodiment, a configuration will be described in which an infrared light image (an invisible light image) is used for noise reduction. Note that infrared light is merely an example of invisible light, and invisible light is not limited to infrared light. Near-infrared light may be used as invisible light, for example.

Configuration of Image Capturing Apparatus 200

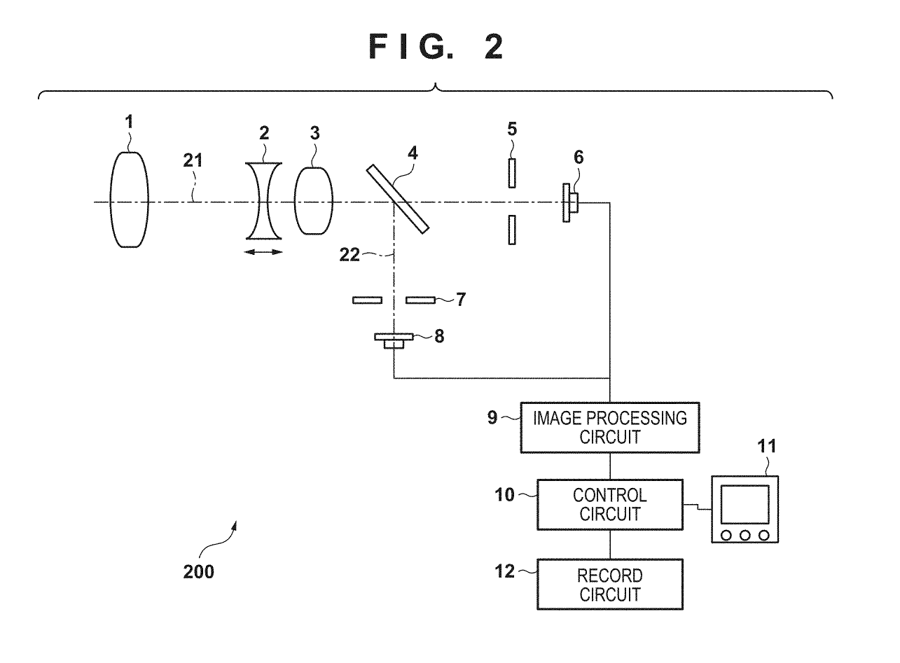

FIG. 2 is a block diagram showing a schematic configuration of an image capturing apparatus 200 that is an example of an image processing apparatus. An objective lens 1, a focus lens 2, and a photographing lens 3 are arranged on an optical axis 21 in this order, and a dichromic mirror 4 for wavelength separation is arranged rearward of these lenses. The dichromic mirror 4 is configured to transmit visible light and reflect infrared light. Transmitted visible light components pass through a visible light diaphragm 5 arranged rearward of the dichromic mirror 4, and are subjected to photoelectric conversion that is performed by a visible light image sensor 6. Accordingly, a visible light image is acquired. On the other hand, infrared light components reflected by the dichromic mirror 4 pass through an infrared light diaphragm 7 arranged on an optical axis 22, and are subjected to photoelectric conversion that is performed by an infrared light image sensor 8. Accordingly, an infrared light image is acquired.

As a result of a visible light image and an infrared light image sharing a portion of an optical system as the above-described configuration, deviation between a position at which a subject is recorded with visible light in an image and a position at which the subject is recorded with infrared light in an image is suppressed. In addition, the positions of the visible light image sensor 6 and the infrared light image sensor 8 have been adjusted such that the same position of a subject can be captured at the same pixel position. Furthermore, a configuration is adopted in which aberration due to wavelength difference can be reduced by arranging the visible light image sensor 6 and the infrared light image sensor 8 at appropriate positions. The visible light image sensor 6 is constituted by a CCD or CMOS sensor, and the infrared light image sensor 8 is constituted by a CCD or CMOS sensor, or an InGaAs sensor. In this embodiment, CMOS sensors that can record an image of 1920 horizontal pixels and 1080 vertical pixels are used as the visible light image sensor 6 and the infrared light image sensor 8.

The output of the visible light image sensor 6 and the output of the infrared light image sensor 8 are connected to a control circuit 10 via an image processing circuit 9. A monitor 11 that has an operation member and a record circuit 12 are connected to the control circuit 10. The control circuit 10 outputs, to the monitor 11, an image captured by the visible light image sensor 6 and the infrared light image sensor 8 and processed by the image processing circuit 9. In addition, the control circuit 10 records this image to the record circuit 12. In addition, it is possible to connect an external storage and an external computer to the control circuit 10, and to transfer shot images to these external devices. In addition, start and end of shooting can be controlled using an external device.

The image capturing apparatus 200 has an infrared light illumination apparatus (not illustrated) including an LED light source that emits infrared light. Particularly in the case where the image capturing apparatus 200 is used for a usage such as night-time monitoring, use of infrared light makes it possible to acquire an infrared light image without making a person within the irradiation area of infrared light feel dazzled or be aware of shooting by the image capturing apparatus 200.

By configuring the image capturing apparatus 200 as described above, it is possible to simultaneously capture a visible light image formed from a visible light wavelength and an infrared light image formed from an infrared light wavelength, using the two image sensors. In addition, a visible light image and an infrared light image can be captured at substantially the same angle of view. In addition, the image capturing apparatus 200 is configured to be able to perform still image shooting and moving image shooting.

In this embodiment, the dichromic mirror 4 is used for separating visible light and infrared light from each other, but as long as the wavelength and light path are branched, a half mirror and a visible light cut filter or an infrared light cut filter may be combined as a matter of course.

Processing for Creating Difference Image

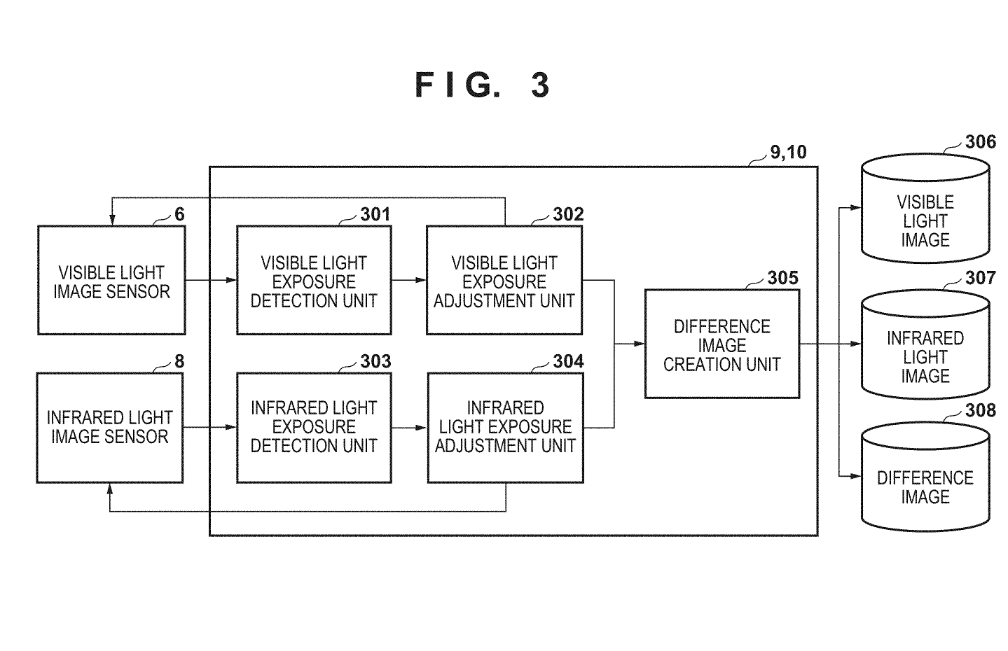

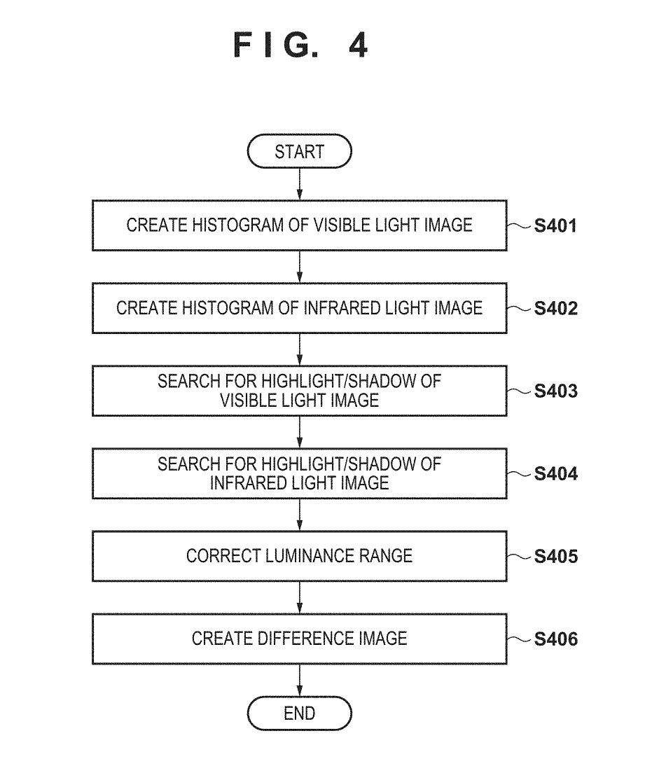

Next, processing for creating (generating) a difference image from a visible light image and an infrared light image will be described with reference to FIGS. 3 and 4. FIG. 3 is a diagram showing functional blocks related to processing for creating a difference image. Functions of a visible light exposure detection unit 301, a visible light exposure adjustment unit 302, an infrared light exposure detection unit 303, an infrared light exposure adjustment unit 304, and a difference image creation unit 305 are achieved by the control circuit 10 executing a control program stored in a ROM (not illustrated) so as to control the image processing circuit 9. The control circuit 10 performs exposure adjustment. Here, an example of image processing for performing exposure adjustment on a moving image will be described.

First, exposure adjustment of visible light will be described. A visible light image that has been output from the visible light image sensor 6 has an RGB (red, green, and blue) signal format. The visible light exposure detection unit 301 integrates luminance values of a visible light image in an area that has been set in advance such as the image center, the entire image, or the like, and outputs the result as a luminance integration value to the visible light exposure adjustment unit 302. Note that a luminance Y1 of the visible light image is obtained in accordance with the following equation:

Y1=0.257R+0.504G+0.098B (1)

Also, the visible light exposure detection unit 301 outputs visible light signals R, G, and B to the visible light exposure adjustment unit 302 in addition to the luminance integration value.

The visible light exposure adjustment unit 302 performs exposure adjustment in order to bring the luminance integration value of visible light that has been input close to a desired value. The exposure adjustment includes adjustment of the visible light diaphragm 5, adjustment of the shutter speed of the visible light image sensor 6, adjustment of the gain of the visible light image sensor 6, and adjustment of the gain that is applied to output of the visible light image sensor 6 by the visible light exposure adjustment unit 302. As a result of the exposure adjustment, a desired exposure amount is achieved in images of the next frame onward. Image data that has been subjected to exposure adjustment is output to the difference image creation unit 305.

Next, exposure adjustment of infrared light will be described. An infrared light image that has been output from the infrared light image sensor 8 has a one-channel-signal (IR) format unlike a visible light image. The infrared light exposure detection unit 303 integrates luminance values of an infrared light image in an area that has been set in advance (the same area as exposure adjustment of visible light), and outputs the result as a luminance integration value to the infrared light exposure adjustment unit 304. Note that a luminance Y2 of the infrared light image is obtained in accordance with the following equation:

Y2=IR (2)

The infrared light exposure detection unit 303 also outputs an infrared light signal IR to the infrared light exposure adjustment unit 304 in addition to the luminance integration value.

The infrared light exposure adjustment unit 304 performs exposure adjustment in order to bring the luminance integration value of infrared light that has been input close to the same desired value as visible light. The exposure adjustment includes adjustment of the infrared light diaphragm 7, adjustment of the shutter speed of the infrared light image sensor 8, adjustment of the gain of the infrared light image sensor 8, and adjustment of the gain that is applied to output of the infrared light image sensor 8 by the infrared light exposure adjustment unit 304. As a result of the exposure adjustment, a desired exposure amount is achieved in images of the next frame onward similar to visible light. Image data that has been subjected to exposure adjustment is output to the difference image creation unit 305. The difference image creation unit 305 performs processing for creating a difference image between the visible light image and the infrared light image.

FIG. 4 is a flowchart of processing for creating a difference image. Processing of the steps in this flowchart is executed through functions of the difference image creation unit 305 that are achieved by the control circuit 10 executing a control program stored in the ROM (not illustrated) so as to control the image processing circuit 9, unless specifically stated otherwise.

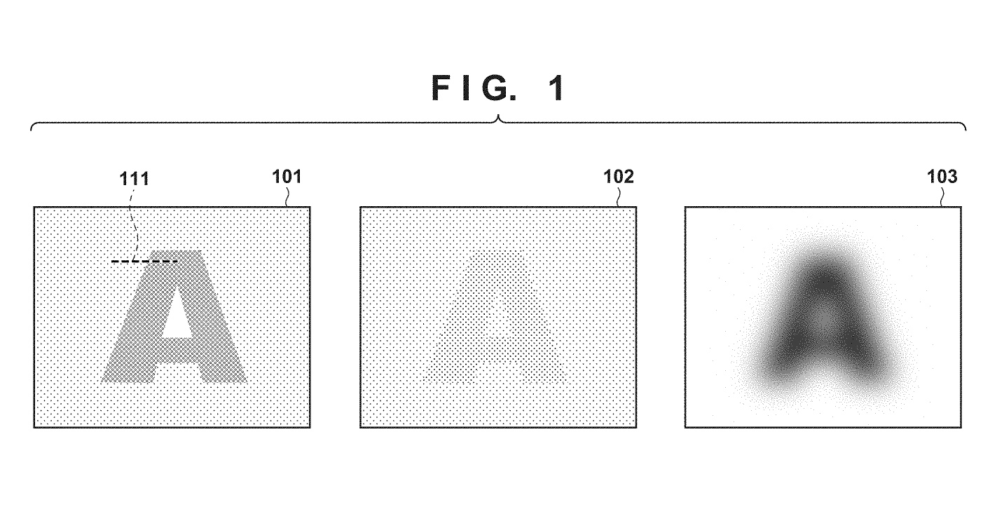

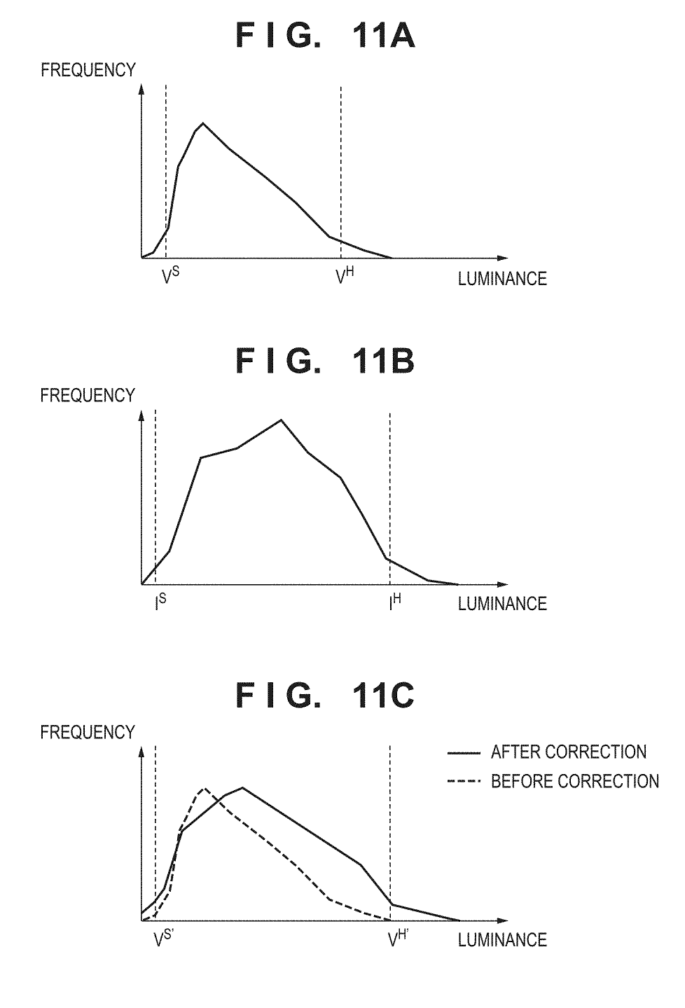

In step S401, the difference image creation unit 305 creates a histogram of a visible light image. Specifically, the difference image creation unit 305 converts RGB signals into luminance signals Y1 in accordance with Expression 1 above, and creates a luminance histogram. Note that a conversion equation other than Expression 1 may be used as an equation for converting RGB signals into luminance signals Y1. FIG. 11A shows an example of the histogram that is created from the visible light image 101 (FIG. 1).

In step S402, the difference image creation unit 305 creates a histogram of an infrared light image. Specifically, the difference image creation unit 305 converts IR signals into luminance signals Y2 in accordance with Expression 2 above, and creates a luminance histogram. Note that a conversion equation other than Expression 2 may be used as an equation for converting IR signals into luminance signals Y1. FIG. 11B shows an example of the histogram that is created from the infrared light image 102 (FIG. 1).

In step S403, the difference image creation unit 305 searches for a highlight point and a shadow point of the visible light image. Specifically, the difference image creation unit 305 adds frequencies from the maximum luminance of the histogram, and obtains a luminance value corresponding to n % of the total number of pixels, and sets the luminance value as a highlight point V^{H} (see FIG. 11A). Similarly, the difference image creation unit 305 adds frequencies from the minimum luminance of the histogram, obtains a luminance value corresponding to m % of the total number of pixels, and sets the luminance value as a shadow point V^{S} (see FIG. 11A). In this embodiment, it is assumed that the variable n for the highlight point is 8, and the variable m for the shadow point is 10.

In step S404, the difference image creation unit 305 searches for a highlight point I^{H} and a shadow point I^{S} of the infrared light image by performing processing similar to the processing of step S403 (see FIG. 11B). The same values as those of the visible light image are used as the values n and m.

In step S405, the difference image creation unit 305 performs processing for making the luminance range (the difference between the highlight point and the shadow point) of the visible light image and the luminance range of the infrared light image match each other. In this embodiment, the difference image creation unit 305 extends the luminance range of the visible light image or the infrared light image, whichever is narrower, so as to match the luminance range of the other image that is wider. In the case where the luminance range of the visible light image is narrower, and the luminance range of the visible light image is extended to match the luminance range of the infrared light image, luminance V of the visible light image before being corrected is corrected to be luminance VM in accordance with the following equation:

V^{M}=(I^{H}−I^{S})/(V^{H}−V^{S})×(V−V^{S})+I^{S} (3)

As a result of this correction processing, the highlight points between the visible light image and the infrared light image match, and the shadow points between the visible light image and the infrared light image match. FIG. 11C shows the histogram of the corrected visible light image. In FIG. 11C, a solid line indicates the histogram of the corrected visible light image, and a broken line indicates the histogram of the visible light image before being corrected. As shown in FIG. 11C, a highlight point V^{H′} and a shadow point V^{S′} of the corrected visible light image take values close to the highlight point I^{H} and the shadow point I^{S} of the infrared light image, respectively.

Note that, in Expression 3, if the corrected luminance V^{M} exceeds a predetermined range (e.g., 0 to 255), clip processing is performed on the values of the ends of this range. In addition, if the luminance range of the visible light image is broader than that of the infrared light image, it suffices that the values of the visible light image are exchanged with the values of the infrared light image in Expression 3. In addition, a method for making the luminance range of a visible light image and the luminance range of an infrared light image match each other is not limited to the above-described method. For example, the luminance range of an image that is wider may be made to match the luminance range of the other image that is narrower. Alternatively, the luminance range of a visible light image and the luminance range of an infrared light image may be made to match by performing correction for changing the luminance ranges of both the visible light image and the infrared light image to a specific luminance range.

In step S406, the difference image creation unit 305 creates a difference image by subtracting the visible light image (after correction) from the infrared light image. Note that this subtraction is performed in terms of luminance. Accordingly, a difference image represents a difference in luminance. After that, the difference image creation unit 305 stores a visible light image 306, an infrared light image 307, and a difference image 308 to a memory (not illustrated).

By creating a difference image as described above, the luminance difference between the infrared light image and the visible light image due to a difference in properties between visible light and infrared light can be quantitatively expressed. Note that, in this embodiment, luminance range correction is performed so as to make highlight points and shadow points match, but only highlight points may be made to match. In addition, the image processing circuit 9 may perform processing such as y correction or color balance adjustment on the visible light image 306 and the infrared light image 307 as appropriate.

Noise Reduction Processing

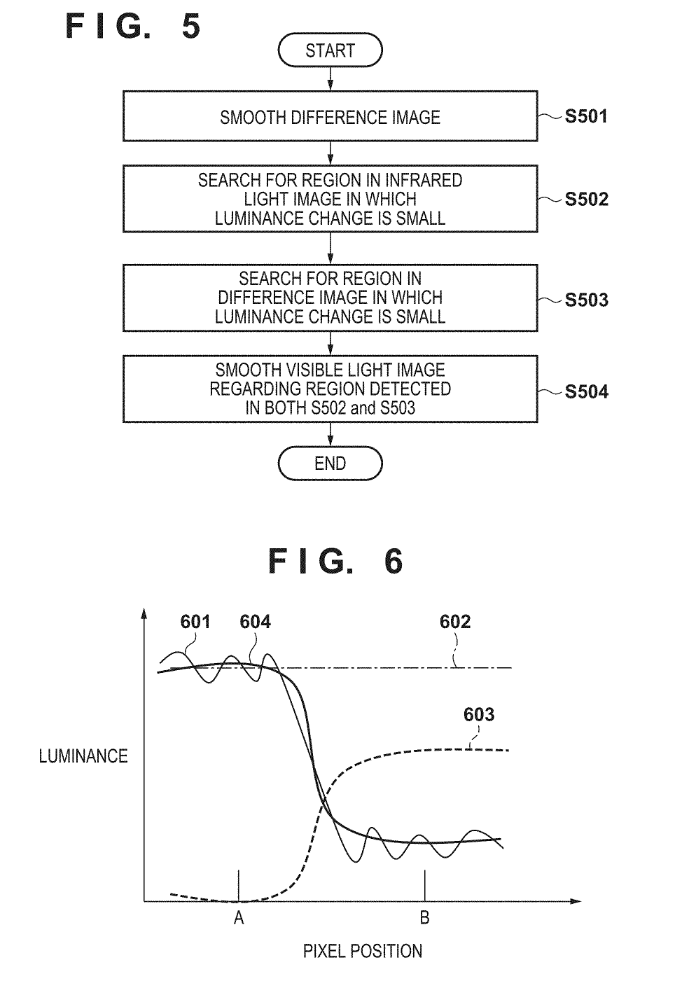

Next, processing for reducing noise in a visible light image will be described with reference to FIGS. 5 and 6. Processing of the steps of the flowchart in FIG. 5 is achieved by the control circuit 10 executing a control program stored in the ROM (not illustrated) so as to control the image processing circuit 9, unless particularly stated otherwise.

FIG. 6 is a diagram schematically showing a luminance profile corresponding to the position 111 of the subject shown in FIG. 1. Assume that the subject is in a low illuminance environment regarding a visible light wavelength region. Also, the image capturing apparatus 200 emits infrared light to achieve an environment in which the illuminance of an infrared wavelength is moderate. Furthermore, as described above, the visible light image sensor 6 and the infrared light image sensor 8 are adjusted such that the same position of a subject is shot at the same pixel position.

In FIG. 6, the horizontal axis indicates pixel position, and the vertical axis indicates luminance. A position A corresponds to the white background portion of the subject, and a position B corresponds to the letter portion of the subject. A luminance profile 601 corresponds to the visible light image 101, and a luminance profile 602 corresponds to the infrared light image 102.

Since the subject is in a low-illuminance environment regarding a visible light wavelength region, many noise components are superimposed on the visible light image 101. Therefore, in the luminance profile 601, the luminance rises and falls locally. On the other hand, the infrared light image 102 includes little noise, and thus the luminance profile 602 is substantially flat. However, the letter portion of the subject is unlikely to appear with infrared light since infrared light and visible light have different wavelength properties. Therefore, there is no luminance difference between the position A and the position B.

Next, referring to FIG. 5, in step S501, the control circuit 10 smoothes a difference image that represents the luminance difference between the infrared light image and the visible light image. A bilateral filter whose smoothing intensity changes according to the edge amount of the infrared light image can be used for the smoothing. The bilateral filter is expressed as Expression 4. In this embodiment, the filter intensity is changed according to the luminance difference, and thus f(i,j) indicates a difference image signal, and g(i,j) indicates a luminance signal of the infrared light image.

$$Out ( i , j ) = \frac{\begin{matrix}{\sum }_{n = - w}^{w} {\sum }_{m = - w}^{w} f ( i + m , j + n ) exp ( - \frac{{m}^{2} + {n}^{2}}{2 {σ}_{1}^{2}} ) \\ exp ( - \frac{g ( x , j ) - {g ( i + m , j + n )}^{2}}{2 {σ}_{2}^{2}} )\end{matrix}}{\begin{matrix}{\sum }_{n = - w}^{w} {\sum }_{m = - w}^{w} exp ( - \frac{{m}^{2} + {n}^{2}}{2 {σ}_{1}^{2}} ) \\ exp ( - \frac{g ( x , j ) - {g ( i + m , j + n )}^{2}}{2 {σ}_{2}^{2}} )\end{matrix}} \qquad ( 4 )$$

The filter intensity changes according to changes in the luminance of the infrared light image, and thus intense smoothing is applied to a region in which the luminance of infrared light does not change, and weak smoothing is applied to a region in which the luminance of infrared light changes. In the example in FIG. 6, the luminance change of infrared light is small, and thus the difference image will be intensely smoothed.

A luminance profile 603 in FIG. 6 represents a luminance profile of the smoothed difference image. In the white background portion in the vicinity of the position A, both the visible light luminance and the infrared light luminance are high, and thus the difference therebetween is small. On the other hand, in the letter portion in the vicinity of the position B, the luminance is low since the letter is visible in visible light, and the luminance is high since the letter is not visible in infrared light, and the difference therebetween is large. In addition, the intensity and the frequency of smoothing are implemented such that the lower-illuminance environment the subject is in (in a low illuminance environment, the amplitude of noise is likely to be high), the higher the intensity is and the lower the frequency is, and the higher the illuminance is, the lower the intensity is and the higher the frequency is.

Note that a smoothing technique such as moving average may be adopted, and a smoothing filter whose smoothing intensity changes according to changes in the infrared luminance is more desirable. In the case of moving average, a similar effect is acquired by changing an averaging area for moving average according to the difference between the luminance signals of pixels of interest in the infrared light image and luminance signals of pixels to be averaged in the infrared light image.

In step S502, the control circuit 10 searches for a region in the infrared light image in which luminance change is small. This search can be executed using any known technique, and for example, is performed by detecting a region in which pixels of luminance values that are within a predetermined range are continuous (a region in which variation of luminance is within the predetermined range).

As described above, the visible light image includes many noise components (see the luminance profile 601). Therefore, if the luminance of the visible light image is used, there is a possibility that the white background portion and the letter portion in which the luminance change of the subject is small in FIG. 1 cannot be detected (in other words, a possibility that a non-edge region is incorrectly determined as an edge region). In addition, if a range of luminance values that serves as a criteria for determining “a region in which luminance change is small” is widened in order to make it possible to detect the white background portion and the letter portion, there is a possibility that the boundary portion between the white background portion and the letter portion will be detected (in other words, a possibility that an edge region will be incorrectly determined as a non-edge region). Therefore, in the case where the luminance of the visible light image is used in order to determine a smoothing region (region in which noise components are reduced) of the visible light image, there is a possibility that noise components in a non-edge region will not be appropriately reduced, or edge components will be lost.

On the other hand, the infrared light image includes few noise components (see the luminance profile 602). Therefore, if the luminance of the infrared light image is used, the white background portion and the letter portion in which luminance change of the subject is small in FIG. 1 can be appropriately detected. Therefore, in this embodiment, the control circuit 10 uses the luminance of the infrared light image in order to determine a smoothing region in the visible light image in step S502. However, as described above, there is a possibility that there is barely a difference in luminance between the white background portion and the letter portion in the infrared light image. Therefore, if the luminance of the infrared light image is used, there is a possibility that a boundary portion between the white background portion and the letter portion in which the luminance change of the subject is large in FIG. 1 is incorrectly detected (in other words, a possibility that an edge region is incorrectly determined as a non-edge region). In view of this, as will be described below, the control circuit 10 takes not only the infrared light image but also the difference image into consideration in order to determine a smoothing region of the visible light image.

In step S503, the control circuit 10 searches for a region in which luminance change is small, in the difference image smoothed in step S501. This search can be executed using any known technique similar to step S502, and for example, is performed by detecting a region in which pixels of luminance values that are within a predetermined range are continuous (a region in which variation of luminance is within a predetermined range). As indicated by the luminance profile 603 in FIG. 6, in the difference image, luminance change is small in the vicinity of the position A, and luminance change is small in the vicinity of the position B as well, but the luminance change is large in the vicinity of the center between the position A and the position B (namely, in a boundary portion between the white background portion and the letter portion). Therefore, as a region in which luminance change is small, the white background portion and the letter portion are detected individually, but the boundary portion is not detected.

In step S504, the control circuit 10 smooths the luminance of the visible light image regarding a region detected in both steps S502 and S503 (namely, a region included in both the region detected in step S502 and the region detected in step S503). The luminance profile 604 in FIG. 6 represents a luminance profile of the smoothed visible light image. By setting a smoothing target region to the region detected both in step S502 and step S503, noise components can be reduced while suppressing loss of edge components of the visible light image.

As described above, according to the first embodiment, the image capturing apparatus 200 creates a difference image that represents the difference in luminance between a visible light image and an infrared light image, and searches for a region in which luminance change is small, in both the infrared light image and the difference image. The image capturing apparatus 200 then smooths the visible light image regarding a region detected as a region in which luminance change is small in both the infrared light image and the difference image. This makes it possible to reduce noise components while suppressing loss of edge components of the visible light image.

Note that when shooting an infrared light image and a visible light image, control may be performed so as to step down (narrow) the infrared light diaphragm 7 more than the visible light diaphragm 5. This makes it possible to emphasize an edge in the infrared light image more than the visible light image, make the visible light image be slightly blurred, and increase the effect of noise reduction.

In addition, the image capturing apparatus 200 may be configured to determine whether or not the illuminance in the shooting environment regarding a visible light wavelength region is smaller than or equal to a threshold value, and if the illuminance is smaller than or equal to the threshold value, executes the above-described smoothing of the visible light image. In general, noise components of a visible light image increase in a low-illuminance environment, and thus noise components can be reduced effectively by performing smoothing in the case where the illuminance is smaller than or equal to the threshold value. The image capturing apparatus 200 may be provided with an illuminance meter in order to determine the illuminance. Alternatively, the image capturing apparatus 200 may be configured to determine the illuminance based on exposure information.

### Second Embodiment

In a second embodiment, processing for reducing noise by compositing a visible light image and an infrared light image will be described. In the second embodiment, a basic configuration of an image capturing apparatus 200 is similar to that of the first embodiment. Differences from the first embodiment will be mainly described below.

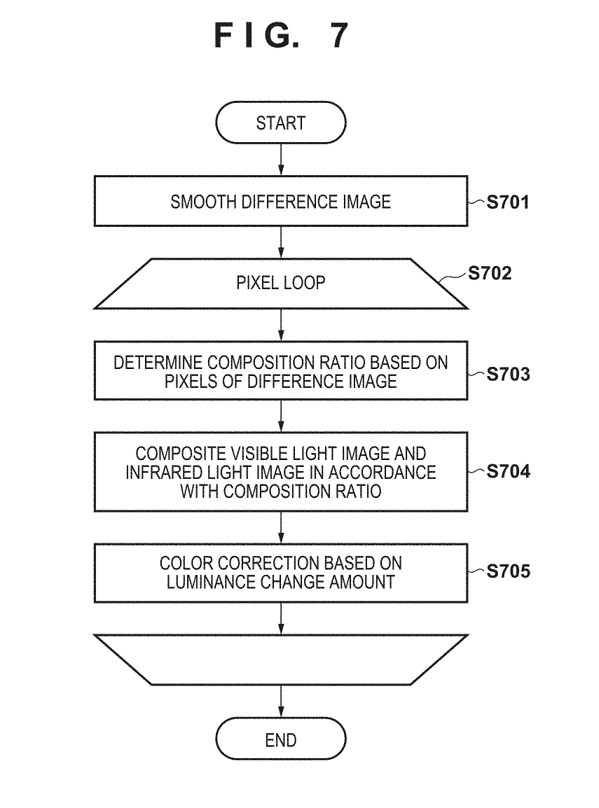

FIG. 7 is a flowchart of noise reduction processing. Processing of the steps of this flowchart is achieved by a control circuit 10 executing a control program stored in a ROM (not illustrated) so as to control an image processing circuit 9, unless specifically stated otherwise.

In step S701, the control circuit 10 smoothes a difference image between an infrared light image and a visible light image. The processing here is similar to the processing in step S501 in FIG. 5.

Step S702 represents a processing loop regarding composition target pixels (pixels of interest). Processing in steps S703 to S705 is repeatedly executed in units of pixels.

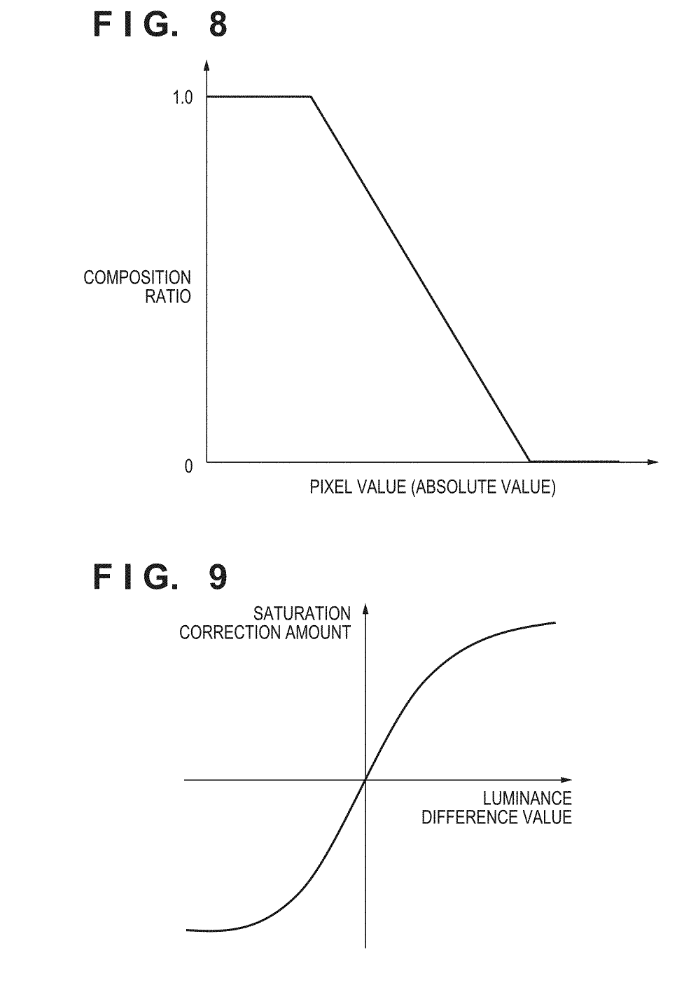

In step S703, the control circuit 10 determines a composition ratio of the visible light image to the infrared light image based on a pixel value of the difference image smoothed in step S701 (in other words, the luminance difference between the visible light image and the infrared light image). FIG. 8 shows the relationship between the luminance difference and the composition ratio. The composition ratio takes a value of 0 to 1, and if the composition ratio=0, the visible light image and the infrared light image are composited at a ratio of 1:0. On the contrary, when the composition ratio=1, the visible light image and the infrared light image are composited at a ratio of 0:1. The pixel values of the difference image are expressed as absolute values. In the case where the difference between the luminance of the visible light image and the luminance of the infrared light image is small, it is considered that the property difference between visible light and infrared light is small, and thus the ratio of the infrared light image is increased by increasing the composition ratio. On the other hand, in the case where the difference between the luminance of the visible light image and the luminance of the infrared light image is large, it is considered that the property difference between visible light and infrared light is large, and thus the ratio of the visible light image is increased by decreasing the composition ratio. In the difference image, the luminance range of the visible light image and the luminance range of the infrared light image have been made to match each other by performing luminance range correction processing in step S405 in FIG. 4, and thus it is possible to directly obtain a composition ratio from a difference value. Regarding a subject in which the property difference between visible light and infrared light is small, the infrared light image is prioritized. On the other hand, regarding a subject in which the property difference is large, the visible light image is prioritized.

In step S704, the control circuit 10 composites the luminance of the visible light image and the luminance of the infrared light image in accordance with the composition ratio obtained in step S703. Letting the composition ratio be a, the luminance of a pixel of interest of the visible light image be Y1 (see Expression 1), and the luminance of a pixel of interest of the infrared light image be Y2 (see Expression 2), composite luminance YC is obtained in accordance with the following equation:

YC=αY2+(1−α)Y1 (5)

A composition ratio is determined in units of pixels according to the difference between the visible light image and the infrared light image, and thus in a subject region in which the property difference between visible light and infrared light is large, the luminance of the visible light image is prioritized. Therefore, it is possible to reduce the likelihood that a large luminance change will occur due to the images being composited.

In step S705, the control circuit 10 performs color correction corresponding to luminance change in step S704. Although the difference between the luminance of the visible light image and the luminance of the composite image (composite luminance) is relatively small as described above, in the case where saturation is not corrected according to changes in luminance, only the luminance changes, and thus there is a possibility that a composition result will be acquired in which a color is lost, or color reproduction that is outside the color reproduction gamut and is unnatural is included. In order to perform color correction processing, the control circuit 10 obtains the absolute value of the difference between a saturation correction center CC and the luminance Y1 of the visible light image and the absolute value of the difference between the saturation correction center CC and the composite luminance YC, and obtains the difference (luminance difference value) between the two absolute values of the differences in accordance with the following equation:

luminance difference value=|Y1−CC|−|YC−CC| (6)

The control circuit 10 then determines a saturation correction amount H based on the obtained luminance difference value. This determination is made in accordance with a graph shown in FIG. 9, for example.

As an example, a case is considered in which the luminance Y1 of the visible light image=150, the composite luminance YC=180, and the saturation correction center CC=127. In this case, the luminance difference value is −30 in accordance with Expression 6. The saturation correction amount H takes a negative value from the graph shown in FIG. 9, and the control circuit 10 performs saturation correction in a direction in which saturation is suppressed. As another example, the luminance difference value=20 in the case where the luminance Y1 of the visible light image=150, the composite luminance YC=130, and the saturation correction center CC=127. The saturation correction amount H takes a positive value from the graph shown in FIG. 9, and the control circuit 10 performs saturation correction in a direction in which saturation is emphasized.

By determining the saturation correction amount H in this manner, the correction amount changes so as to increase when the composite luminance changes in a direction toward the luminance center relative to the luminance of the visible light image, and to decrease when the composite luminance changes in a direction away from the luminance center. Color correction can be achieved by correcting the saturation according to the obtained saturation correction amount.

As described above, according to the second embodiment, the image capturing apparatus 200 composites a visible light image and an infrared light image such that the larger the absolute value of the difference between the luminance of the visible light image and the luminance of the infrared light image is, the higher the ratio of the visible light image is, and the smaller the absolute value of the difference is, the higher the ratio of the infrared light image is. This makes it possible to reduce noise components while suppressing luminance change in the visible light image.

Note that, similar to the first embodiment, the image capturing apparatus 200 may be configured to determine whether or not the illuminance of the shooting environment is smaller than or equal to a threshold value regarding a visible light wavelength region, and if the illuminance is smaller than or equal to the threshold value, execute the above compositing of a visible light image and an infrared light image.

### Other Embodiments

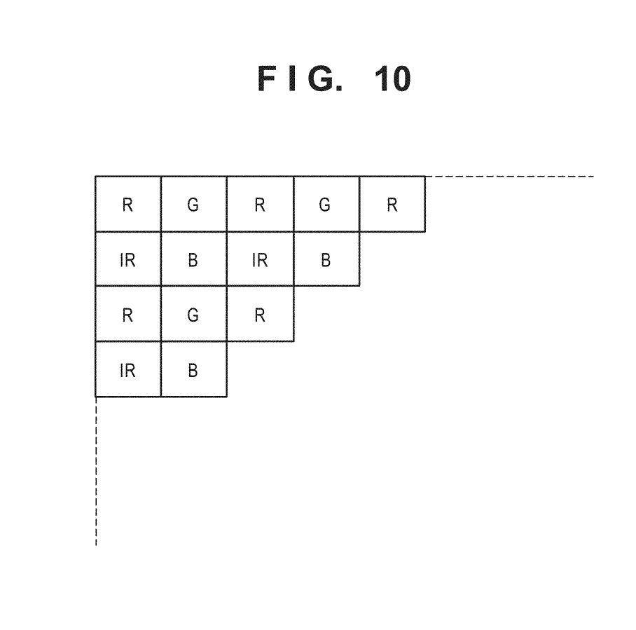

In the above embodiments, a configuration is used in which an infrared wavelength and a visible wavelength are separated through optical path branching to generate an infrared light image and a visible light image. However, the image capturing apparatus 200 may be configured such that infrared light signals in addition to R, G, and B visible light signals are generated by an image sensor using a filter as shown in FIG. 10. In the example in FIG. 10, a filter for visible light and a filter for invisible light are arranged on the image sensor. Specifically, the filter in FIG. 10 includes a filter R of pixels that are mainly sensitive to red light, a filter G of pixels that are mainly sensitive to green light, a filter B of pixels that are mainly sensitive to blue light, and a filter IR of pixels that are mainly sensitive to near infrared light. By repeatedly arranging these filters on the image sensor surface, it is possible to obtain a visible light image constituted by R, G, and B pixels and an infrared light image constituted by IR pixels.

In addition, the visible light image sensor 6 and the infrared light image sensor 8 may have different resolutions. Moreover, the image capturing apparatus 200 may be configured to output a difference image, change a range in which the difference is large to have an arbitrary color phase and output the image, and detect a subject that has a property difference between visible light and infrared light. This makes it possible to detect a subject such as a wig that has a property difference between visible light and infrared light, and display the subject such that it is easy to visually recognize whether or not a person is in disguise.

Furthermore, in the first embodiment, smoothing for noise reduction is performed in proximate pixel regions, but, in the case of a moving image, smoothing may be performed in proximate pixels in temporally proximate frames.

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-098410, filed May 17, 2017 which is hereby incorporated by reference herein in its entirety.

What is claimed is:

1. An image processing apparatus comprising:
one or more processors; and
memory storing instructions that, when executed by the one or more processors, cause the image processing apparatus to perform operations comprising:
acquiring a visible light image generated by shooting a subject with visible light and an invisible light image generated by shooting the subject with invisible light;
generating a difference image that represents a difference in luminance between the visible light image and the invisible light image;
detecting, from the invisible light image, a first region in which variation of luminance is within a first range, and detecting, from the difference image, a second region in which variation of luminance is within a second range; and
smoothing luminance in the visible light image regarding a region included in both the first region and the second region.

2. The image processing apparatus according to claim 1, wherein
the smoothing is executed in a case where illuminance of a shooting environment of the visible light image is smaller than or equal to a threshold value.

3. The image processing apparatus according to claim 1, wherein
the generating is generating the difference image after correcting luminance of at least one of the visible light image and the invisible light image so as to make a luminance range of the visible light image and a luminance range of the invisible light image match each other.

4. The image processing apparatus according to claim 1, wherein
the invisible light is near infrared light.

5. An image processing apparatus comprising:
one or more processors; and
memory storing instructions that, when executed by the one or more processors, cause the image processing apparatus to perform operations comprising:
acquiring a visible light image generated by shooting a subject with visible light and an invisible light image generated by shooting the subject with invisible light;
generating a difference image that represents a difference in luminance between the visible light image and the invisible light image; and
compositing luminance of the visible light image and luminance of the invisible light image in units of pixels, at a composition ratio determined in units of pixels based on an absolute value of a pixel of the difference image,
wherein the compositing is, in a case where the absolute value is a first value, compositing corresponding pixels of the visible light image and the invisible light image at a first composition ratio, and in a case where the absolute value is a second value that is larger than the first value, compositing corresponding pixels of the visible light image and the invisible light image at a second composition ratio in which a ratio of the visible light image is larger than in a case of the first composition ratio.

6. The image processing apparatus according to claim 5, wherein the operations further comprises:
determining a saturation correction amount in units of pixels based on a difference in units of pixels between luminance of a composite image acquired through the compositing and luminance of the visible light image.

7. The image processing apparatus according to claim 5, wherein
the compositing is executed in a case where illuminance of a shooting environment of the visible light image is smaller than or equal to a threshold value.

8. The image processing apparatus according to claim 5, wherein
the generating is generating the difference image after correcting luminance of at least one of the visible light image and the invisible light image so as to make a luminance range of the visible light image and a luminance range of the invisible light image match each other.

9. The image processing apparatus according to claim 5, wherein
the invisible light is near infrared light.

10. An image capturing apparatus comprising:
the image processing apparatus according to claim 1; and
an image capturing unit configured to capture the visible light image and the invisible light image.

11. The image capturing apparatus according to claim 10, wherein the operations further comprises:
performing control so as to narrow a diaphragm for capturing the invisible light image further than a diaphragm for capturing the visible light image.

12. An image capturing apparatus comprising:
the image processing apparatus according to claim 5; and
an image capturing unit configured to capture the visible light image and the invisible light image.

13. The image capturing apparatus according to claim 12, wherein the operations further comprises:
performing control so as to narrow a diaphragm for capturing the invisible light image further than a diaphragm for capturing the visible light image.

14. An image processing method executed by an image processing apparatus, comprising:
acquiring a visible light image generated by shooting a subject with visible light and an invisible light image generated by shooting the subject with invisible light;
generating a difference image that represents a difference in luminance between the visible light image and the invisible light image;
detecting, from the invisible light image, a first region in which variation of luminance is within a first range, and detecting, from the difference image, a second region in which variation of luminance is within a second range; and
smoothing luminance in the visible light image regarding a region included in both the first region and the second region.

15. An image processing method executed by an image processing apparatus, comprising:
acquiring a visible light image generated by shooting a subject with visible light and an invisible light image generated by shooting the subject with invisible light;
generating a difference image that represents a difference in luminance between the visible light image and the invisible light image; and
compositing luminance of the visible light image and luminance of the invisible light image in units of pixels, at a composition ratio determined in units of pixels based on an absolute value of a pixel of the difference image,
wherein the compositing is, in a case where the absolute value is a first value, compositing corresponding pixels of the visible light image and the invisible light image at a first composition ratio, and in a case where the absolute value is a second value that is larger than the first value, compositing corresponding pixels of the visible light image and the invisible light image at a second composition ratio in which a ratio of the visible light image is larger than in a case of the first composition ratio.

16. A non-transitory computer-readable storage medium which stores a program for causing a computer to execute an image processing method comprising:
acquiring a visible light image generated by shooting a subject with visible light and an invisible light image generated by shooting the subject with invisible light;
generating a difference image that represents a difference in luminance between the visible light image and the invisible light image;
detecting, from the invisible light image, a first region in which variation of luminance is within a first range, and detecting, from the difference image, a second region in which variation of luminance is within a second range; and
smoothing luminance in the visible light image regarding a region included in both the first region and the second region.

17. A non-transitory computer-readable storage medium which stores a program for causing a computer to execute an image processing method comprising:
acquiring a visible light image generated by shooting a subject with visible light and an invisible light image generated by shooting the subject with invisible light;
generating a difference image that represents a difference in luminance between the visible light image and the invisible light image; and
compositing luminance of the visible light image and luminance of the invisible light image in units of pixels, at a composition ratio determined in units of pixels based on an absolute value of a pixel of the difference image,
wherein the compositing is, in a case where the absolute value is a first value, compositing corresponding pixels of the visible light image and the invisible light image at a first composition ratio, and in a case where the absolute value is a second value that is larger than the first value, compositing corresponding pixels of the visible light image and the invisible light image at a second composition ratio in which a ratio of the visible light image is larger than in a case of the first composition ratio.
